(19) United States
(12) Patent Application Publication
(10) Pub. No.: US 2004/0039097 A1
(43) Pub. Date: Feb. 26, 2004

(54) Water-based metallic paint

(76) Inventors: Hiroyuki Nagano, Nishikamo-gun (JP); Yasushi Nakao, Nishikamo-gun (JP); Takayuki Ono, Nishikamo-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/647,474

(22) Filed: Aug. 26, 2003

(30) Foreign Application Priority Data
Aug. 26, 2002 (JP) 2002-244467

(51) Int. Cl. C08K 3/08

(52) U.S. Cl. 524/439; 106/272

(57) ABSTRACT

This invention provides a water-based metallic paint which comprises a resin composition for water-based paint and metallic pigment, said water-based metallic paint containing 5-15 parts by weight of polyamide resin per 100 parts by weight of the resin composition for water-based paint, and the storage modulus of elasticity of the paint liquid immediately after spray coating of said water-based metallic paint being at least 100 Pa/20° C. under the conditions of 0.5 Pa stress and 0.1 Hz frequency, said water-based metallic paint forms coating excelling in flip-flop property and being free of metallic unevenness.

### BACKGROUND OF THE INVENTION

1. Field of the Invention

This invention relates to novel water-based metallic paint which excels in flip-flop property and is capable of forming metallic coating free of metallic unevenness.

2. Description of the Prior Art

Water-based metallic paints which are prepared by mixing resin compositions for water-based paints and metallic pigments in water are known and widely used as top coating enamel for outer panels of automobiles. Such water-based metallic paints are convenient for resources-saving and reducing environmental pollution, but are subject to the defects that they show insufficient flip-flop property and are apt to develop metallic unevenness. Such defects are fatal for top coating enamels for outer panels of automobiles and their urgent elimination is in strong demand.

### SUMMARY OF THE INVENTION

The object of the present invention is to overcome the defects and to provide water-based metallic paint which excels in flip-flop property and is capable of forming coating free of metallic unevenness.

We have engaged in concentrative studies to now find that the above object could be accomplished by incorporating in a water-based metallic paint containing a resin composition for water-based paint and metallic pigment, a polyamide resin at a specific ratio and furthermore adjusting the formed composition such that the storage modulus of elasticity of the applied paint liquid immediately after spray coating becomes no lower than 100 Pa/20° C. under a stress of 0.5 Pa and frequency of 0.1 Hz, and whereupon the present invention is completed.

Thus, according to the present invention, a water-based metallic paint comprising a resin composition for water-based paint and metallic pigment is provided, which water-based metallic paint is characterized by containing 5-15 parts by weight of a polyamide resin per 100 parts by weight of the resin composition for water-based paint, and having a storage modulus of elasticity of the applied paint liquid immediately after spray coating of not lower than 100 Pa/20° C. under a stress of 0.5 Pa and frequency of 0.1 Hz (which water-based metallic paint is hereafter referred to as “the present composition”).

Hereinafter the present composition is explained in further details.

### DETAILED DESCRIPTION OF THE INVENTION

As the resin composition for water-based paint, which serves as the resin binder component in the present composition, any of those per se known water-soluble or water-dispersible resin compositions for paint can be used. More specifically, resin compositions comprising at least one base resin selected from acrylic resins, vinyl resins, polyester resins, urethane resins and the like, in which hydrophilic groups such as carboxyl and crosslinkable functional groups such as hydroxyl are concurrently present per molecule; and a crosslinking agent which can cure the base resin upon reacting with said crosslinkable functional groups in these base resins, for example, hydrophobic or hydrophilic alkyl etherified melamine resin, (blocked) polyisocyanate compound and the like, can be used. The compositional ratios of the base resin to the crosslinking agent in such a resin composition are: based on the total solid content of said two components, that of the base resin is 50-90%, in particular, 65-85%, by weight and that of the crosslinking agent, 50-10%, in particular, 35-15%, by weight.

Metallic pigment refers to flaky pigments which impart glittering brightness or iridescence to their coatings. As customary materials for metallic paint, flaky aluminium, vapor-deposited aluminium, alumina, bismuth oxychloride, mica, titanium oxide-coated mica, iron oxide-coated mica, micaceous iron oxide, titanium oxide-coated silica, titanium oxide-coated alumina, iron oxide-coated silica, iron oxide-coated alumina and the like can be used. Generally preferred size of such metallic pigment flakes lies within a range of 1-30 μm in longitudinal direction and within a range of 0.001-1 μm in thickness. Suitable blend ratio of such metallic pigment in the present composition is generally within a range of 0.5-40, in particular, 1-30, parts by weight per 100 parts by weight (as solid) of the resin composition for water-based paint.

As the polyamide resin to be blended in the metallic paint according to the invention, for example, fatty acid polyamide wax can be used, one of the corresponding commercial goods being DISPALON®-AQ-600 (Kusumoto Chemicals, Ltd.). Suitable blend ratio of such a polyamide resin in the present composition is within a range of 5-15, preferably 6-13, parts by weight, per 100 parts by weight (as solid) of the resin composition for water-based paint. Where the blend ratio of the polyamide resin is less than 5 parts by weight, improvement in flip-flop property is generally insufficient. Whereas, where it is more than 15 parts by weight, storage stability of the present composition is reduced, in particular the metallic pigment is apt to settle, and furthermore the coating film of the composition tends to have less adherability.

Where necessary, the present composition may suitably contain still other customary additives for paint, such as phosphate-containing resin composition, antisettle agent, solid color pigment, electrostatic assistant, leveling agent and the like.

The present composition is preferably applied by spray-coating system, such as electrostatic coating, air spray coating, airless spray coating or the like.

It is important to formulate the present composition in such manner that the storage modulus of elasticity of the liquid paint immediately after its adherence to the object surface where the composition is applied onto the object by spray-coating system, is no less than 100 Pa/20° C., in particular, in a range of 100-200 Pa/20° C., under the conditions of 0.5 Pa stress and 0.1 Hz frequency. By regulating the storage modulus of elasticity of said liquid paint as applied to come under this range, such effects are achieved as improving orientation of metallic pigment in the coating film and enabling formation of metallic coating excelling in flip-flop effect.

Here the storage modulus of elasticity means the ratio of strain to elastic stress of the same phase. For instance, a paint applied onto an object by electrostatic application is scraped off in one minute of the application, which serves as an “applied paint liquid” sample. Its viscoelasticity is measured with Cone & Plate type viscometer to determine the storage modulus of elasticity. Viscometer, Reostress® RS150 (Haake AG) is an example of Cone & Plate type Viscometer, with which the storage modulus of elasticity under the stress equivalent to the gravity exerted on the applied paint liquid can be easily determined.

Storage modulus of elasticity can be easily adjusted, for example, by varying the polyamide resin content in the present composition. It is also possible to effect the adjustment by controlling the blended amount(s) of other component(s), such as base resin and crosslinking agent.

The present composition can be formulated by dispersing above-described resin composition for water-based paint, metallic pigment and polyamide resin, in an aqueous medium such as water, optionally with still other additive(s) for paint, in the manner similar to cases of preparing ordinary water-based metallic paint.

The present composition can be directly applied onto metallic or plastic objects such as outer panels of cars, e.g. passenger cars, trucks, motorcycles and buses; outer panels of household electric appliances, and the like; or it may be applied to such objects which are advancedly coated with a primer such as cationic electropaint and optionally further with an intermediate paint, after the film(s) of the applied paint(s) are cured. In that occasion, it is preferable to give an advance chemical treatment to the surface of metallic object to which the present composition is to be applied, using for example phosphate or chromate. As primers and intermediate paints, those per se known paints can be used.

The present composition is applicable onto those objects (including those which have been advancedly coated with primers and optionally also with intermediate paints) by spray-coating system such as electrostatic coating, airless spraying, air-spraying and the like. Normally suitable thickness of the coating film lies within a range of 5-30 μm, in particular, 10-20 μm, as cured coating film. Coating film can be cured by heating at about 100- about 180° C. for around 10-40 minutes.

In the coating film formed of the present composition, metallic pigment is uniformly oriented in parallel with the coated surface, and the coating exhibits better flip-flop (FF) property compared with metallic coating formed of conventional metallic paint. Moreover the metallic pigment is uniformly dispersed in the coating and metallic unevenness is almost nil. The invention thus achieves conspicuous effects.

The spray-coating method of the present composition is not critical, while it is preferred to adopt “2-stage system” in which the coating is conducted dividedly in at least two stages, preferably in two stages. In particular, where the first stage coating is made thicker (e.g., around 5-20 μm) and the second and optionally subsequent stage coating is given a thickness of each 20-70% that of the first stage coating, the metallic pigment in the upper layer(s) more easily orient paralleling with the coated surface, and the flip-flop property further favorably improves.

On coating of the present composition, clear paint can be applied either after or before curing the former.

As the clear paint, thermosetting paint which forms colorless or colored transparent coating film is preferred. More specifically, paint compositions containing thermosetting resin composition and organic solvent, and optionally coloring pigment, metallic pigment, ultraviolet absorber or the like, as blended therewith, can be named. As the thermosetting resin composition, for example, compositions comprising, as base resin, acrylic, polyester, alkyd, fluorinated, urethane, silicone-containing resin or the like, having crosslinkable functional groups such as hydroxyl, carboxyl, silanol and epoxy groups; and crosslinking agent which can react with said crosslinkable functional groups to cure the base resin, e.g., melamine resin, urea resin, (blocked) polyisocyanate compound, epoxy compound or resin, carboxyl-containing compound or resin, acid anhydride, alkoxysilane-containing compound or resin and the like, can be named. The ratios of the base resin and crosslinking agent in said thermosetting resin composition are, based on the total solid weight of the two components, the base resin 50-90%, in particular, 65-80%, and the crosslinking agent, 50-10%, in particular, 35-20%.

Of these thermosetting resin compositions, it is preferred to use those compositions comprising acrylic resin (base resin) having crosslinkable functional groups such as carboxyl, silanol or epoxy groups, and a crosslinking agent selected from epoxy compound or resin, carboxyl-containing compound or resin and acid anhydride, which are capable of forming coating excelling in acid resistance and abrasion resistance.

Application of such a clear paint can be practiced by, for example, first coating an object with a present composition as earlier described; curing the coating by heating or pre-heating it at a temperature not higher than 100° C., or leaving it uncured; and applying onto the coated surface a clear paint whose solid content at the application time is adjusted to about 30- about 80% by weight, by such means as electrostatic coating, airless spraying or air spraying. Suitable thickness of the clear paint coating is within a range of 5-100 μm, in particular, 20-80 μm, in terms of cured film thickness. After application of a clear paint, the coated surface is heated at about 100- about 180° C., preferably at about 120- about 160° C., for around 10-40 minutes to cure the coating film(s).

### EXAMPLES

Hereinafter the present invention is explained in further details referring to an Example and Comparative Example, it being understood that the scope of this invention is not limited by these Examples. In the Example and Comparative Example, parts and percentages are by weight (solid content) and given coating film thickness refers to the cured coating film.

### Example 1

Mixing and dispersing 75 parts of a hydroxyl-containing acrylic resin ^{note 1)}, 25 parts of a melamine resin ^{note 2)}, 20 parts of Alumi-paste® GX-180A (Asahi Kasei Corporation, an aluminium flake paste) and 7.5 parts of DISPALON®AQ-600 in deionized water, a water-based metallic paint (the present composition) with its viscosity adjusted to 25 seconds/Ford Cup #4/20° C. was obtained. The paint had a storage modulus of elasticity ^{note 3)} of 110 Pa/20° C. note 1) hydroxyl-containing acrylic resin: a copolymer obtained through copolymerization of 38 parts of methyl methacrylate, 17 parts of ethyl acrylate, 17 parts of n-butyl acrylate, 7 parts of hydroxyethyl methacrylate, 20 parts of lauryl methacrylate and 1 part of acrylic acid: number-average molecular weight=50,000, hydroxyl value=54 mgKOH/g note 2) melamine resin: a butyl etherified melamine resin, U-Van® 28-60 (Mitsui-Cytec Co., Ltd.) note 3) Measuring conditions and measuring method of storage modulus of elasticity: The water-based metallic paint as obtained in Example 1 was electrostatically coated with an electrostatic bell coater. The coating conditions were: discharged amount was 250 cc, the number of rotation was 25,000 rpm, shaping air was 500 normal liters, gun speed was 900 mm/sec. and gun distance was 300 mm. The coating was conducted twice (2-stage coating). The paint thus applied onto the object by the electrostatic coating was scraped off after a minute of the application to provide a sample of the applied paint liquid and its storage modulus of elasticity at 0.5 Pa stress and 0.1 Hz frequency was measured with a viscometer, Reostress® RS150 (Haake AG).

### Comparative Example 1

Mixing and dispersing 75 parts of a hydroxyl-containing acrylic resin ^{note 1)}, 25 parts of a melamine resin ^{note 2)} and 20 parts of Alumi-paste® GX-180A (Asahi Kasei Corporation, aluminium flake paste) in deionized water, and the mixture's viscosity was adjusted to 25 sec./Ford Cup #4/20° C. Thus obtained paint had a storage modulus of elasticity ^{note 3)} of 50 Pa/20° C.

Performance Test

Onto steel plates (objects) coated with a cationic electropaint and an intermediate paint, after these coated films were cured, those water-based metallic paints as obtained in Example 1 and Comparative Example 1 were each applied by two-stage operation. The film thickness of the first stage coating was 9 μm and that of the second stage coating was 4 μm. The metallic coatings were then preheated at 80° C. for 3 minutes, and onto which a clear paint ^{note 4)} was applied to a film thickness of 40 μm, followed by 30 minutes' heating at 140° C. to simultaneously cure the two coating films. Thus formed multilayered coating films were subjected to performance tests as follows. The results were as given in Table 1. note 4) clear paint: a paint prepared by mixing and dispersing 50 parts of a carboxyl-containing acrylic resin ^{note 5)}, 50 parts of epoxy-containing acrylic resin ^{note 6)}, 1 part of Tinuvin® 900 (Ciba Geigy, an ultraviolet absorber), 2 parts of an equivalent blend of tetrabutylammonium bromide and monobutylphosphoric acid, and 0.1 part of BYK® 300 (BYK Chemie, a surface regulator) in an aromatic hydrocarbon solvent, and viscosity of the dispersion was adjusted to 20 seconds/Ford Cup No.#4/20° C. note 5) carboxyl-containing acrylic resin: a copolymer obtained through copolymerization of 20 parts of methanol half-esterified product of maleic anhydride, 20 parts of 4-hydroxy-n-butyl acrylate, 40 parts of n-butyl acrylate and 20 parts of styrene: number-average molecular weight=3,500; hydroxyl value=78 mgKOH/g; and acid value=86 mgKOH/g. note 6) epoxy-containing acrylic resin: a copolymer obtained through copolymerization of 30 parts of glycidyl methacrylate, 20 parts of 4-hydroxy-n-butyl acrylate, 30 parts of n-butyl acrylate and 20 parts of styrene: number-average molecular weight=3,000; epoxy content=2.12 mmol/g and hydroxyl value=78 mgKOH/g.

The performance test methods used were as follows.

Flip flop property (FF): Visual evaluation: the coated surface was visually observed at varied angles to examine changes in metallic appearance: ◯ indicates notable variation, meaning good FF; Δ, less variation and inferior FF; X, almost no variation and poor FF. The measured values of FF property are the results of measuring with ALCOPE® LMR 100 (Fuji Industries, Ltd.), indicating the higher the values, the better the FF property.

IV value: Of the reflection of laser light emitted at 45° angle of incidence, the signal output at the angle of light interception at which the intensity of the light becomes the minimum in the regular reflection zone was measured with ALCOPE® LMR 100. The greater numerical value, the more intense the whiteness in the metallic appearance or luster.

Metallic appearance: The result of visual evaluation: ◯: metallic unevenness was hardly recognizable, Δ: metallic unevenness was recognized to a minor degree, and X: metallic unevenness was recognized in many places.

TABLE 1

| | | | Comparative |
|---|---|---|---|
| | | Example 1 | Example 1 |
| Storage modulus of elasticity | | 110 Pa | 50 Pa |
| FF property | visual evaluation | ◯ | X |
| | measured value | 1.8 | 1.4 |

| | | |
|---|---|---|
| IV value | 277 | 179 |
| Metallic appearance | ◯ | X |

1. A water-based metallic paint which comprises a resin composition for water-based paint and metallic pigment, said water-based metallic paint containing 5-15 parts by weight of a polyamide resin per 100 parts by weight of the resin composition for water-based paint, and the storage modulus of elasticity of the paint liquid immediately after spray coating of said water-based metallic paint being at least 100 Pa/20° C. under the conditions of 0.5 Pa stress and 0.1 Hz frequency.

2. A water-based metallic paint according to claim 1, in which the polyamide resin is fatty acid polyamide wax.

3. A water-based metallic paint according to claim 1, which contains 6-13 parts by weight of the polyamide resin per 100 parts by weight of the resin composition for water-based paint.

4. A water-based metallic paint according to claim 1, in which the storage modulus of elasticity of the paint liquid immediately after spray coating of said water-based metallic paint lies within a range of 100-200 Pa/20° C. under the conditions of 0.5 Pa stress and 0.1 Hz frequency.

5. A water-based metallic paint according to claim 1, in which the resin composition for water-based paint is formed of a base resin whose molecules concurrently contain carboxyl and hydroxyl groups per molecule, and a crosslinking agent.

6. A water-based metallic paint according to claim 1, in which the metallic pigment is selected from a group consisting of flaky aluminium, vapor-deposited aluminium, alumina, bismuth oxychloride, mica, titanium oxide-coated mica, iron oxide-coated mica, micaceous iron oxide, titanium oxide-coated silica, titanium oxide-coated alumina, iron oxide-coated silica and iron oxide-coated alumina.

7. A water-based metallic paint according to claim 1, which contains 0.5-40 parts by weight of metallic pigment per 100 parts of the resin composition for water-based paint.

8. A coating method which comprises applying the water-based metallic paint as described in claim 1 onto an object which is advancedly coated with a primer and further optionally with an intermediate paint.

9. A coating method according to claim 8, in which a clear paint is further applied onto the coating of the water-based metallic paint.

10. A coating method according to claim 8, in which the object to be coated is outer panel portion of car bodies.

11. Articles which are coated with the water-based metallic paint as described in claim 1.
